(19) United States
(12) Patent Application Publication
(10) Pub. No.: US 2014/0279606 A1
(43) Pub. Date: Sep. 18, 2014

(54) System and Method to Determine the Total Cost of Regulatory Compliance and the Total Cost of Product Quality

(71) Applicant: BMM INTERNATIONAL, Las Vegas, NV (US)

(72) Inventor: Martin Storm, Victoria (AU)

(73) Assignee: BMM INTERNATIONAL, Las Vegas, NV (US)

(21) Appl. No.: 14/202,071

(22) Filed: Mar. 10, 2014

Related U.S. Application Data
(60) Provisional application No. 61/777,124, filed on Mar. 12, 2013.

(51) Int. Cl. G06Q 30/02; G06Q 30/00

(52) U.S. Cl. CPC G06Q 30/0283; G06Q 30/018
USPC 705/317

(57) ABSTRACT

A system and method to determine the total cost of regulatory compliance and the total cost of product quality. The system and method are particularly directed to recording the costs of staff member activities, associated expenses and fees relating to testing and approving of gaming equipment, including electronic gaming machines such as slot and video games as well as gaming systems such as player tracking, slot accounting, and progressive systems. The method and system are implemented on a server accessible by users to record time and costs. The total cost of compliance and the total cost of product quality can be determined based on the recorded costs including internal costs, external costs, delay costs and probability of failure costs.

### RELATED APPLICATION INFORMATION

This application claims priority benefit from U.S. Provisional Patent Application Ser. No. 61/777,124, filed on Mar. 12, 2013, the entirety of which is incorporated by reference in the present Application.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Systems and methods to test and approve equipment for regulatory compliance have traditionally been in use in a variety of industries. One such industry is the gaming industry where the manufacture and use of products is strictly regulated through a complex structure of laws and statutes that differ from state to state in the United States, as well as in the different Native American jurisdictions in North America, and in other countries around the world. An example of a set of regulations for which gaming equipment must be compliant is shown in version 1.00 of a document entitled “Electronic Gaming Equipment Minimum Technical Standards” published by the Alcohol and Gaming Commission of Ontario in December 2007, which is hereby incorporated by reference. Gaming products and equipment that is to be introduced to a jurisdiction must be certified and approved before they are permitted to be exposed for play to the public in any jurisdiction.

The compliance certification process and product approval for a gaming equipment manufacturer typically follow the product development process. The product development approval process consists of a number of steps that are fairly common across many industries where electronic or microprocessor based equipment is produced. These steps include: 1) analysis and assessment; 2) design; 3) development and 4) quality assurance testing; followed by, 5) compliance certification testing; and ultimately, 6) regulatory approval. Different organizations have different approaches to the steps in the process. For example, one organization may set up individual departments to handle each of the steps independently with interaction between the departments at the transition point between the steps so that feedback is provided at particular milestones for a product. Another organization may apply a team approach where a team of experts is set up to continuously work together providing substantive feedback across each and every step in the process.

In either case, once development has been completed, and the product passes through the quality assurance step, it is ready to be evaluated by a testing laboratory for compliance testing. Compliance testing by a certified testing laboratory usually takes several weeks at a minimum depending on the complexity of the product being submitted. In the case when the product fails during compliance testing, the certification process may take significantly longer given the need to correct all non-compliant issues that are required for resubmission of the product for another round of certification testing. Resubmissions are costly to the gaming equipment manufacturer and delay the gaming equipment manufacturer from deploying the product to market in a timely manner.

Once Compliance Testing has been completed by the testing laboratory and the product has passed the jurisdictional regulatory requirements, a Certification Report is produced and provided by the manufacturer to the gaming regulatory body. The regulatory agency evaluates the report, may perform additional jurisdictional testing of the product and, if found satisfactory, approves the product for placement in the jurisdiction.

Gaming equipment manufacturers are highly incentivized to minimize resubmissions. Any efficiencies that can be achieved in limiting resubmissions reduces the cost of the certification process, but it also reduces the time period for getting product into the commercial marketplace. A faster certification directly translates into improved competitiveness and higher revenues.

Resubmission rates vary widely from industry to industry and company to company within an industry. For the gaming industry, gaming equipment manufacturers' performance varies widely. A relatively high rate of product compliance quality has an average submission rate in the range of 1.6-2.0. It is not unusual for a gaming equipment manufacturer to resubmit product to the testing laboratory multiple times before receiving an approval. The goal of the gaming equipment manufacturer is to receive approval on the first pass, thereby achieving a resubmission rate of zero or a submission rate of 1. Gaming equipment manufacturers, and testing laboratories are constantly seeking ways to improve the certification process and reduce the time for approval.

In view of the complexities associated with the overall process for development of new products and the sub-process of obtaining approvals for those new products across a broad range of gaming jurisdictions, the corresponding total cost of compliance is extremely difficult to predict and manage. In fact, for gaming equipment manufacturers, particularly those operating globally, the expanding regulatory landscape constrains the technology innovation pipeline and delays new product delivery across the various jurisdictions. This imposes business inefficiencies on gaming equipment manufacturers that impacts profitability. Therefore, it is imperative to identify the specific costs resulting from regulatory compliance activities that occur during the product life-cycle to enable gaming equipment manufacturers to better understand the total cost of compliance. Capturing the total cost of compliance provides the ability to manage and improve the processes and procedures end-to-end, throughout the entire organization. This ultimately increases efficiencies, thereby lowering overall costs and resource requirements in their product compliance operations.

### BRIEF DESCRIPTION OF THE DRAWINGS

For a better understanding of the present invention, and to describe its operation, reference will now be made, by way of example, to the accompanying drawings. The drawings show preferred embodiments of the present invention in which:

FIG. 1 is a diagram of a prior art system of electronic gaming machines connected to a network of the type developed and approved for regulatory compliance;

FIG. 2 is a block diagram of a prior art electronic gaming machine with component parts connected to a server;

FIG. 3 is a block diagram of a prior art process to test, certify and approve equipment for regulatory compliance;

FIGS. 4A-F show a process to test, certify and approve equipment for regulatory compliance where the testing laboratory provides input in staged compliance testing that occurs during the quality assurance subprocess including sample checklists and documentation;

FIG. 5 is a block diagram of a testing laboratory system for evaluating, testing and certifying equipment for regulatory compliance;

FIG. 6 is a block diagram of a process to test, certify and approve equipment for regulatory compliance where the testing laboratory provides input in staged compliance testing that occurs during the quality assurance subprocess, including system components associated with the process;

FIG. 7A is a diagram showing the organizational touch points in the regulatory compliance approval process;

FIG. 7B is a process diagram of field issues that occur after the product has been approved by the regulators including the resubmission by the equipment manufacturer to the independent test lab and the regulator;

FIG. 8 is a diagram showing known and hidden costs of the regulatory compliance approval process;

FIG. 9 is a diagram showing a total cost of compliance system;

FIG. 10 is a representation of the product development and deployment lifecycle;

FIG. 11 is a block diagram of a process to test, certify and approve equipment for regulatory compliance where a separate, independent quality assurance arm of the test lab performs and delivers all of the quality assurance work during the quality assurance subprocess; and

FIG. 12 is a block diagram of the total cost of compliance system integrated with the testing laboratory system for evaluating, testing and certifying equipment for regulatory compliance.

### DETAILED DESCRIPTION OF THE INVENTION

The present invention will now be described more fully with reference to the accompanying drawings. It should be understood that the invention may be embodied in many different forms and should not be construed as limited to the embodiments set forth herein. Throughout the Figures, like elements of the invention are referred to by the same reference numerals for consistency purposes.

FIG. 1 shows a group of electronic gaming machines (individually “EGM” or together “EGMs”) 101 with a number of components. EGMs are one type of equipment typically developed by a gaming equipment manufacturer that is then tested and certified by a testing laboratory. EGMs may operate as a stand-alone device or in a network as shown in FIG. 1. Each EGM has a display 105 to show game play and resulting outcomes, and may be in the form of a video display (shown), or alternatively, physical reels. Touch screen displays are included on most EGMs and provide a flexible interface for operation of EGM 101, including displaying symbols 106 during play. Other components include a bill validator (see FIG. 2) and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play, amount won on a particular play, number of coins bet, number of paylines played and other amounts are positioned near the bottom of screen 105. A coin tray 119 at the bottom of EGM 101 is used to catch coins as they are dispensed to a player through coin-out slot 125. It is also common for EGM 101 to include a ticket-in, ticket-out (“TITO”) component that may be part of the bill validator housed inside of EGM 101 that may accept bar coded credits through slot 107 and for which the value of the credits is displayed on meters 117 upon a ticket being inserted.

EGMs 101 may be connected to a network 215 that includes a server 201 that communicates with EGMs 101 for a variety of functions that may include administration of player tracking and slot accounting, customer loyalty programs, bonusing or other functionality and features.

FIG. 2 is a block diagram of EGM 101 connected to server based system 201 and showing certain internal components of EGM 101. All operational functions of EGM 101 are controlled by a controller 131 such as a microprocessor housed inside EGM 101 that is resident on a game board 133. The controller executes instructions that include operation of a random number generator 135 (“RNG”) that is usually implemented in software and stored in a memory 137. The internal components of EGM 101 are well known to those of ordinary skill in the art. Game outcomes are determined based on the results corresponding to the numbers selected by RNG 135. A bill validator 139 also has ticket printing capabilities (or a separate ticket printer may be included). Bill validator 139 accepts currency in the form of bills, or tickets from a player and adds credit to meters 117 on EGM 101.

Server system 201 such as a player tracking system, a slot accounting system or a bonusing system may also be connected to EGM 101. These types of systems are typically connected to EGM 101 either through a separate interface board (not shown) or directly to different components of EGM 101 including but not limited to game board 133. A player tracking system may also include other components installed on EGM 101 such as a player tracking display 205, a keypad 207 and a card reader 209. These components allow for direct interaction between server 201 and the player to receive information from the player on keypad 207 or through information on a card inserted into card reader 209, and to display information to the player on display 205. A network is established between external system 201 and EGM 101 by network connection 215. The network may be connected to all EGMs 101 in a casino or any smaller subset of EGMs 101.

It will be understood that the type of network over which data is communicated can be one of several different types of networks. This includes a Local Area Network (LAN), Wide Area Network (WAN), an intranet or the Internet. Other proprietary networks could also be used without departing from the principles of the invention. This would include such networks as a Windows network or an Ethernet network.

FIG. 3 is a block diagram of a prior art process 300 to develop, test and approve equipment for regulatory compliance to be able to place it for use into a jurisdiction. Process 300 has a number of steps that are performed by a gaming equipment manufacturer, a testing laboratory or a combination of the two. In a first analysis step 305, a gaming equipment manufacturer evaluates the requirements for a new or improved product. This includes assessing the markets to be served by the product, the regulatory requirements for those markets, available technology, cost of development and other factors influencing a decision to proceed with product development. From this effort, a set of functional specifications is prepared for the product to be developed.

Once the functional specification document is finalized, the gaming equipment manufacturer is ready to move to the second step 310 which is the design step. Design step 310 involves performing engineering design activities to develop a suitable functional design on which a new or improved product will be based. The functional specification is converted to a technical specification and the engineering organization identifies and determines the implementation of appropriate technology. Design step 310 also includes evaluating vendors to supply components, modules or other part configurations, a development timeline, a cost estimate and quality assessment.

Upon completion of a design plan, development of a product can begin to take form in development step 315. The development team takes the technical specifications and uses them to build the product. In development step 315, software is coded, hardware component designs may be prototyped (if applicable), and vendor products are evaluated for integration. A prototype is produced and tested to confirm that the design works and meets the technical and functional specifications.

After a prototype is produced and appropriately tested to ensure that it functions as designed, the prototype is turned over to quality assurance (“QA”) at step 320. QA takes the product and runs it though a series of tests for functionality, security, performance, and to ensure that it meets compliance with all regulations. Any issues found during QA step 320 are identified and categorized as critical or non-critical. Critical flaws are sent back to the design team or the development team for resolution which may require re-design or modification to the development program.

For each of analysis step, 305, design step 310, development step 315 and QA step 320, the process is performed by the gaming equipment manufacturer. However, once QA step 320 is completed, the product is provided to the testing laboratory and the performance of the process moves from the gaming equipment manufacturer to the testing laboratory.

The testing laboratory conducts its own compliance testing at step 325. Compliance testing involves testing the product for the specific requirements established by the jurisdiction in which the gaming equipment manufacturer intends to place the product for commercial use. If critical flaws are identified by the testing laboratory, the product is returned to the gaming equipment manufacturer for resolution, along with a report outlining the results of the testing so that the manufacturer may take necessary steps to re-design, modify or otherwise revise the product to get into appropriate form to pass through compliance testing.

If the product passes compliance testing, a certification report is issued to the gaming equipment manufacturer at step 330 by the testing laboratory. A copy of this report is also typically provided to the agency within each jurisdiction that oversees the regulatory compliance of the equipment for that jurisdiction at step 350. The game is then released by the manufacturer to the regulators at step 350. The regulatory agency may then grant approval at step 360 so that the product can be exposed for play in that jurisdiction.

It should be understood that to date, development and approval process 300 has been performed with a “barrier” or “wall” 335 between the gaming equipment manufacturer and the testing laboratory. This barrier represents a division in the performance of the steps in the process between: 1) the gaming equipment manufacturer on the left side of line 335 for analysis, design, development and QA; and 2) the testing laboratory on the right side for compliance testing and certification reporting. The interaction between the manufacturer and the lab has been restricted to passing the product from the manufacturer to the lab after QA step 320 has been completed the first time through the process as indicated by arrow 340, and back from the lab to the manufacturer if a failure results at the compliance testing step 325 as represented by arrow 345. Once a failure has been corrected, the product is resubmitted by passing the product back to the testing laboratory a second time as represented by arrow 340. It is not unusual for a product to get passed back and forth from the manufacturer to the testing laboratory as indicated by arrows 340 and 345 a number of times before all compliance requirements are met. Throughout the process, it is not part of the standard routine for the testing laboratory to engage in the steps on the left side, or the manufacturer to participate in the steps on the right side of wall 335.

An important reason for maintaining the separation of steps between the gaming equipment manufacturer and the testing laboratory is to maintain the integrity of the testing laboratory as an independent entity whose testing and results are not subject to the influence of the gaming equipment manufacturer whose equipment is being tested. It is critically important that any new processes and systems implemented to increase efficiencies and enable faster, more cost-effective solutions to testing and certification for regulatory compliance maintain the integrity of the testing process. Otherwise, gaming patrons, gaming equipment manufacturers, gaming establishment operators, governmental agencies charged with regulatory oversight, the general public and other constituencies will lose trust in the process. This would severely damage the reputation of the gaming industry that has been largely built over the years on an established process that independently tests product to ensure the equipment operates as intended and as advertised, and that all testing is conducted fairly.

To date, regulatory compliance testing has been generally conducted as described with respect to FIG. 3 above. While this process has been effective, there are a number of steps that can be taken to improve the quality of the product, increase the efficiency of the process, reduce the time for products to reach the market and lower the costs of regulatory compliance testing, all while maintaining the independence of the testing laboratory. These desirable objectives may be achieved by enabling inputs of the testing laboratory in the specific step of quality assurance process 320.

FIG. 4A shows a block diagram of a new process to test and certify equipment for regulatory compliance where the testing laboratory provides staged compliance testing across the quality assurance step 320 that follows product development before the final product testing step 325. In this newly established process 400, the testing laboratory provides independent feedback at the various substeps of the quality assurance step 320 above barrier 335 (between the equipment manufacturer and the testing laboratory) in two ways: 1) the testing laboratory provides input to the compliance testing elements needed for the gaming equipment manufacturer to develop an integrated QA and compliance checklist at step 430 and provides evaluation, tools, instruction and audits as part of staged compliance testing of the manufacturer's products 435; and 2) the testing laboratory then independently tests for compliance of the manufacturer's products 325.

The additional components of staged compliance testing where the testing laboratory provides input and reviews the manufacturer's checklists during quality assurance step 320 may include the compilation and confirmation of one or more integrated quality assurance and compliance checklists 405, tests that run math models and source code 410, the compilation and execution of test scripts 415, the preparation of test reports 420 and the development and submission of a complete standardized package to the testing laboratory 425 that will improve the efficiency of prior art process 300. The testing laboratory will review, analyze and approve integrated checklists and related methodologies 430 prior to the manufacturer executing the tests. The testing laboratory reviews and audits the compliance testing performed by the manufacturer, resulting in an audit report 435.

The particular tests to be run, for example in the case of EGM 101 may be to check the artwork displayed on the machine as outlined with respect to FIGS. 4B1 to 4B3 which shows a sample integrated artwork testing checklist. As can be seen from this document on the first page which is FIG. 4B1, a table 450 including a set of requirements is presented with a “Pass,” “Fail” or “N/A” (not applicable) check box 455 corresponding to each requirement. Also included is a space 460 for the applicable regulation to be indicated. In some instances, quality assurance tests may be systematically sequenced with the compliance tests to perform the required tests as efficiently as possible. The second and third pages, which are FIG. 4B2 and FIG. 4B3 respectively, include additional test procedures. It should be noted that table 450 includes a testing laboratory reference number (“TL Ref#”) for each entry in table 450 in the left-most column.

For compilation and confirmation of an integrated quality assurance and compliance checklist 405, the integration of the testing checklists start with the checklist used by the equipment manufacturer when performing their Quality Assurance (“QA”) testing. This QA checklist is reviewed with the checklist used by the testing laboratory for compliance testing and consolidated into a single checklist that combines both QA and compliance tests for the manufacturer. A sample QA checklist 470 and a sample compliance checklist 480 are shown in FIGS. 4C and 4D respectively, for the testing by the manufacturer (QA checklist) and the testing laboratory (compliance checklist) of artwork to be displayed on an EGM. QA checklist 470 has a number of items 1.1-1.5 that specify requirements for the display of artwork. In the past, the manufacturer used QA checklist 470 to ensure that it has met all requirements with respect to the design of the artwork to be displayed. Likewise, the testing laboratory used a separate compliance checklist 480 to ensure that the artwork met all regulatory requirements. This checklist is shown in FIG. 4D1-4D2 and includes much of the same information as QA checklist 470, along with additional testing to be handled by the testing laboratory.

During the process of consolidation, tests that are duplicated on both checklists are eliminated so the tests that are performed by the manufacturer are performed once prior to the testing laboratory tests in step 325. The sequencing of the QA and compliance checklists is aggregated. In that case, when QA and compliance testing are performed on the same areas of the cabinet or game, the integrated testing is much more efficient compared to when it is performed separately. The result is shown in the sample integrated checklist of FIG. 4B.

The math and source code testing 410 of gaming equipment manufacturer software is a critical element of the compliance testing process. Math and source code testing is performed to verify that the game performs as intended. Some examples of the tests that are conducted to ensure that the game software complies are as follows: (a) testing of game rules; (b) testing the method of arriving at the game outcome through one or more random numbers from the RNG that determine the same reel stop positions; (c) testing for cheats or hidden functionality: (d) testing for functionality that could cause the game to behave outside of its intended use; and (e) a comparison of the par sheet (or paytable), game explanation and math in the source code to verify that the expected outcomes in the math matches the source code, that the defined payouts for the game match what is on the help screen, and confirmation of the specified payout percentage(s) to the player.

A sample compliance checklist for source code used in EGM 101 is shown in FIG. 4E, which consists of four pages labeled as corresponding FIGS. 4E1-4E4. As can be seen in FIG. 4E, a header section 485 includes a key to identify particular information such as “AFT” for advance funds transfer, Critical Memory, “EFT” for electronic funds transfer, “EPROM” for erasable programmable read only memory, and “WAT” for wagering account transfer. A technical standards box 487 is also included to identify the technical standard under which the source code is to be tested. Below header 485 is compliance source code testing checklist 489 similar to table 480 in FIG. 4D for artwork. The number of tests for checking source code is typically extensive and may run for numerous pages. Checklist 489 includes a listing of many tests run on source code for EGM 101 as shown on FIGS. 4E1-4E4. It should be understood that the list of tests shown in checklist 489 is only a sample and is not intended to be an exhaustive list of the tests to be run. A pass/fail check block 491 is shown near the end of checklist 489 on page 4 in FIG. 4E4 which is followed by a signature block 493 to be completed by the testing laboratory. Checklist 489 contains many individual tests to be performed on the source code.

As with checklist 480 for artwork, checklist 489 for source code is presented in a table format with a testing laboratory reference number (“TL REF #”) column. A description column includes an outline of the particular test to be performed. A “pass-fail-N/A” column includes checkboxes for pass, fail and not applicable, and also a space for identifying the particular regulation for which the test is directed. Finally, a “Notes” column is available for making notes.

The gaming equipment manufacturer is responsible for compiling the QA and compliance checklists into the integrated checklist and test scripts 405. The test scripts 415 are the specific tests and methodologies to be used to test a hardware or software component, which ensures that the product meets the functional and compliance requirements needed in order to place the product into the marketplace. The management of the testing laboratory then reviews this integrated checklist to ensure that required tests and methodology are included. This integrated checklist is approved by the testing laboratory prior to beginning the testing.

The gaming manufacturer performs the testing 410 and maintains records of each test performed in a checklist 415 and the outcome of each test is prepared in a test report 420. The testing outcomes may be pass/fail or a numerical result. The results are documented on the integrated checklist. Any issues that arise are documented on the checklist as well. Issues may be associated with how and what test is run, a concern about how a regulation was interpreted, any defects encountered that may or may not affect the product's approval status and other information that may be helpful in the process of the compliance testing at the testing laboratory. This checklist is the main part of the test report and is submitted to the testing laboratory as part of the submission package in step 425.

When a gaming equipment manufacturer submits a product to a testing laboratory for compliance testing 425, there is a standardized package that is provided to the testing laboratory that includes, but is not limited to: (a) identification of the product(s) to be tested; (b) documentation outlining the expected performance of the product; (c) a list of the jurisdictions for which the gaming equipment manufacturer is seeking approval; (d) a set of key contacts at the equipment manufacturer to whom questions may be directed, etc.; and (e) any other pertinent information that will assist the testing laboratory in streamlining the efficiency of the testing. By augmenting the results of the staged compliance testing performed by the gaming equipment manufacturer with reviews or audits by the testing laboratory that evaluates the testing being performed, the work by the testing laboratory to perform the independent tests at step 325 is more efficient. This is because the testing laboratory starts its own independent testing having familiarity with the product and with an expectation of product performance. A standardized package submission document would include one or more integrated checklists like the sample checklist shown in FIG. 4B. The integrated checklist is completed by the manufacturer along with a cover letter explaining the request for approval and including identification information for the manufacturer, the jurisdiction in which approval is sought, the particular regulations of the jurisdiction for which compliance testing is to be performed, information related to the product to be tested, and any other information that the manufacturer includes to ensure that the testing laboratory understands the request and can perform suitable testing. A sample of such a letter is shown in FIG. 4F.

The process outlined where the gaming equipment manufacturer provides testing results to the testing laboratory for the staged compliance testing portion of the QA substeps shortens the time for products to reach the market thereby increasing revenue and profits for the gaming equipment manufacturer. It also reduces costs because rework efforts are handled more efficiently saving time and money, including labor efforts on the part of employees of the gaming equipment manufacturer. Forecasting of product release times is also more dependable because the gaming equipment manufacturer and the testing laboratory while working independently are following a similar process, and information is incorporated into the testing performed by the gaming manufacturer at the early stages with a single transfer of responsibility after the quality assurance and staged compliance testing is complete.

To support process 400, a system 500 shown in FIG. 5 is securely operated and maintained by the testing laboratory. System 500 is networked between a number of different parties including the testing laboratory, gaming manufacturers and other clients 510 of the testing laboratory, and governmental regulators 515. The toolbox is accessible to the testing laboratory employees through a client application system to toolbox central database 505 which has multiple modules that perform a number of different tasks to streamline the process from accepting a submission letter to producing the final certification report for testing projects received and completed. For example, toolbox 505 captures, stores and analyzes metrics including costs, productivity, cycle time and quality, and serves as the primary interface to the employees of the testing laboratory.

Toolbox 505 runs on one or more servers 520 at the center of system 500. The servers 520 may be dedicated servers located at the facilities of the testing laboratory, or they may be located remotely accessed by the testing laboratory over a network. Servers 520 may also be servers available for lease in whole or in part through a cloud based service such as that offered by Amazon.com or other operators of server farms.

It will be understood that the type of network over which data is communicated can be one of several different types of networks. These networks include a Local Area Network (LAN), Wide Area Network (WAN), an intranet or the Internet. Other proprietary networks could also be used without departing from the principles of the invention. This would include such networks as a Windows network or an Ethernet network.

Toolbox 505 has a number of modules that are shown in FIG. 5 and described as follows. A jurisdictional approval reporting module (“JARS”) 525 for gaming equipment manufacturers that is accessible over a secure network so that the gaming equipment manufacturer(s) may submit projects to the testing laboratory as well as track and manage those projects through to approval. The submission of a new project involves entering a new product type or name with other information related to the product such as a list of product components, a list of jurisdictions where the manufacturer is seeking approval, corresponding technical documentation, and documentation of any prior history of testing performed by this or any other testing laboratory.

An online approval technology module 530 that maintains a database of certification/recommendation letters and evaluation reports, regulatory approvals, revocations and field verifications. Online approval technology module 530 is a web based application which provides secure access to any certification letters and data related to a specific licensing agency, manufacturer, or gaming operator. Upon successful completion, each project has a record stored in online approval technology module 530 which provides the data described above.

A compliance administration management module (“CAMS”) 535 for supporting technical compliance by maintaining a database of regulatory requirements and testing laboratory checklists. Management and maintenance of the repository is securely controlled by access levels, and user accounts.

A toolbox report module 540 for reporting project metrics such as the estimated versus actual costs and time charged against the estimate. Toolbox report module 540 is designed to generate all reports for toolbox 505 except for certification reports which are generated from certification report module 575.

A project management module 545 for managing testing laboratory projects, completion of quality assurance and certification of gaming equipment. Project management module 545 is designed to control project information by providing users with the capability to add and edit project information. In addition, there are controls which enable the user to keep track of the historical project progression and document irregularities. Each project is assigned a code which is directly related to a specific manufacturer or regulator. Additionally all projects may be separated by region and location for better management yet remain available to all users who are granted the appropriate access level.

An item tracking system module 550 for tracking and storing any components or software received from external sources (clients, regulators, etc.). Item tracking system 550 keeps track of the locations of all physical items received on the premises such as product samples. Item tracking system 550 tracks any actions taken with an item and provides information on the current status or historical activity associated with the location of the item.

A time tracking and invoicing module 555 for tracking the time of testing laboratory personnel and other expenses associated with a particular project that may be invoiced to a client. Time tracking and invoicing system 555 provides the user with the ability to track time spent on specific tasks and document detailed information regarding the task. Time tracking and invoicing module 555 works in conjunction with project management module 545, business development module 570, and employee management module 565. The primary purpose of time tracking and invoicing system 555 is to provide data for final invoicing and metrics related to costs, productivity, cycle time and quality.

A regulator management module 560 that houses regulator contact and licensing information including licensing fees, the status of the license and renewal dates. Regulator management module 560 manages profiles of the licensing agencies for which the testing laboratory holds or is in the process of being granted a license, and provides alerts when licensing deadlines require action. The entries in regulator management module 560 are used to provide data for a number of other modules such as project management module 545 which requires the information for reporting and accurate management of a project. In addition, regulator management module 560 ensures that licensing for a specific jurisdiction recognizes the testing laboratory's certification reports for compliance testing and approval.

An employee management module 565 is used for managing testing laboratory employee data related to user accounts, access levels and billing information. Employee management module 565 provides data to project management module 545, and time tracking and invoicing module 555.

A business development module 570 manages current and potential new business opportunities being pursued by a testing laboratory. It has the capabilities to manage and maintain the database of all client relations, contact information and business relations. In addition, this database is used in project management module 545, time tracking and invoicing module 555, item tracking module 550, and toolbox report module 540.

A certification report module 575 that provides product assessment and certification reports and transfer letters for cross-jurisdictional approvals between one jurisdictional authority and another. To accomplish these tasks, certification report module 575 houses standardized report templates and imports data from project management module 545 and business development module 570.

A regulatory export services module 580 is a system designed for regulators that require scheduled exports of project related certification report data (but not the actual certification report itself).

FIG. 6 is a block diagram of a process to test, certify and approve equipment for regulatory compliance where the testing laboratory is able to provide compliance information and feedback in the quality assurance subprocesses, and showing system components associated with the overall process. As discussed with respect to the block diagram of FIG. 4, the testing laboratory and the gaming equipment manufacturer interact during the quality assurance process and the individual subprocess steps 405-425 making up quality assurance process and staged compliance steps 320 performed by the manufacturer and testing laboratory respectively. In addition, FIG. 6 shows the points in the process where the applications running on system 500 access toolbox 505, jurisdictional approval reporting module 525, compliance administration management module 535, online approval technology 530 and certification report module 575.

As discussed with respect to FIG. 3, a gaming equipment manufacturer performs analysis for a new product at step 305. During this analysis phase, the gaming equipment manufacturer may begin to utilize system 500. This occurs through the use of jurisdictional approval reporting system 525 which is represented with an access line 605. A gaming equipment manufacturer that is a subscriber to this service is able to access compliance administration management tool 535 through the jurisdictional approval reporting system 525, and is able to review the compliance criteria to incorporate any jurisdictional requirements into the analysis of the product at the time the design is being assessed. After the gaming equipment manufacturer completes the analysis step, design and development takes place at steps 310 and 315.

At quality assurance and staged compliance step 320, the testing laboratory becomes actively involved in the process at each substep 405-425 as described with respect to FIG. 4. As can be seen, the gaming equipment manufacturer (also referred to as “client”) may have its testing reviewed and audited by the testing laboratory through each substep 405-425 of the staged compliance portion of the quality assurance step 320. The handoff of responsibility in the process at barrier 335 remains so that the testing laboratory can conduct independent compliance testing. However, the earlier staged compliance testing steps of the QA process conducted by the gaming equipment manufacturer are performed with input from the testing laboratory. The ongoing feedback via reviews and audit of QA and staged compliance step 320 and substeps 405-425 will also lead to more streamlined and efficient testing at step 325 and will reduce the amount of exchanges in compliance testing step 325 as indicated by submission and resubmission arrows 655a and 655b.

During QA and staged compliance step 320, the testing laboratory and the client access toolbox 505. At QA step 320, toolbox 505 provides the client with the ability to input the project parameters, track the progress of testing through the QA process and gain status of the test projects submitted. The testing laboratory may also access toolbox 505 at QA step 320. The transparency with the client at this step allows the testing laboratory to review prior notes and deficiencies that the manufacturer has uncovered during their testing, and be able to determine if the required corrections have been made satisfactorily using toolbox 505 and to provide feedback to the client for each substep 405-425 during reviews and audits. The testing laboratory and the client may also access jurisdictional approval reporting module 525 at QA step 320. This allows the client to formally submit the project to the testing laboratory for certification testing and the testing laboratory to receive the electronic file of the tests performed and the corresponding results achieved by the manufacturer.

When toolbox 505 is accessed by either the client or the testing laboratory during the QA step 320, compliance administration management module 535 is checked by toolbox 505 to determine applicable regulatory requirements and testing laboratory checklists.

Once quality assurance 320 and compliance testing 325 have been completed, the process continues as in the past with certification reports, submission and regulatory approval being handled at steps 330, 350 and 360, respectively. These actions are handled by online approval technology 530 and toolbox certification report module 575 which are each accessed to develop the certification report and to load the approval letter into online approval technology 530 which is then made available to clients and regulators through both a push and/or pull arrangement depending on each jurisdiction's regulatory requirements for notification of product that has been tested and certified.

FIG. 7A is a diagram showing the organizational touch points in the regulatory compliance approval process. As can be seen from this diagram, there are a number of organizational entities that are involved in the different stages 700 of the process for obtaining regulatory compliance approval. These organizational entities include groups within the gaming equipment manufacturer for analyzing, conceptualizing and designing a product 705. Once the analysis has been performed and a concept and design have been formulated, a new product is developed by the development group 710. The quality assurance group 715 within the gaming equipment manufacturer reviews the product thoroughly to ensure that it operates as expected and within the parameters of the regulatory requirements for each jurisdiction. If any revisions or modifications are required to be made to the new product as determined by quality assurance testing, the department at the gaming equipment manufacturer responsible for rectification 720 manages that process.

Once the gaming equipment manufacturer completes quality assurance and rectifies any operational issues, the new product is sent to the technical compliance department 725 of the gaming equipment manufacturer for submission to an external testing laboratory 730 for regulatory compliance testing. As described in detail above, regulatory compliance testing may result in a product approval or failure. In the case of a failure, a report is prepared by the testing laboratory and provided to the gaming equipment manufacturer. The manufacturer must then rectify the causes of the failure and resubmit the product for re-testing. If the product is certified by the testing laboratory 730, either the testing laboratory or the technical compliance department 725 prepares a report that is sent to the regulatory agency 735 of each particular jurisdiction where approval is sought for jurisdictional approval. The regulators will conduct their own review of the submission and approve the product for placement in their jurisdiction.

In addition to the different organizational entities 705-735, the sales and marketing group 740 and the field services group 745 of the gaming equipment manufacturer are also impacted by the compliance process. The sales and marketing group 740 has launch activities that may be planned. Any delays will cause changes to the schedule. Similarly, field services 745 must install and service the new product. Any delays in launching the product resulting from a failed test directly impacts field services organization 745. In addition, if a problem with a product surfaces after a product has been placed for play in a jurisdiction, field services 745 may be required to make modifications to the product in the field. If a product must be modified, customers may need to first contact sales and marketing 740 to learn about the issues and how they will be impacted. It should be understood that other organizational entities may also be impacted by regulatory compliance. As mentioned, the end-user customers who are buying and operating the products have a strong interest in the regulatory approval process being effective and efficient so that products may be installed as soon as possible and so that any modifications to products operating in their establishments are minimized.

As reflected in FIG. 7A, the involvement of the numerous organizational entities puts tremendous pressure on the groups within the gaming equipment manufacturer (concept and design 705, development 710, QA 715, rectification 720 and technical compliance 725) to maximize the efficiency of the regulatory compliance process. Certification testing and compliance has traditionally been viewed as a cost center that does not contribute to the bottom line of the business and does not support competitive advantage or shareholder value for the gaming equipment manufacturer. Certification testing and compliance has instead been seen as a drag on the product development lifecycle and on profits.

One reason that the regulatory compliance process has been viewed as a cost center is that it is difficult, if not impossible, to determine the total cost of compliance for a particular product, or for determining the total cost of compliance across a gaming equipment manufacturer's operations for a given time period. A problem in making such a determination is that while there are a number of known costs, there are also a variety of hidden costs associated with the regulatory compliance process that have been difficult to assess and attribute directly to the process. The present invention addresses these cost attribution issues and provides a system and method to determine the total costs of compliance.

One example of the difficulty in determining the total cost of compliance is that a product may be recalled from the field, even after it has received regulatory approval. These product recalls impact the equipment manufacturer in three ways. First, the recall involves a considerable amount of rework expense to correct the field issue. Then there is a cost to the equipment manufacturer's reputation, which translates into lost sales. Finally, while the manufacturer is working on the recall, other products are delayed causing a backlog for new product releases and additional revenues.

FIG. 7B is a diagram showing the process 750 for field issues that occur after the product has been approved by the regulators including the resubmission by the equipment manufacturer to the independent test lab and the regulator. Field issues are part of the hidden costs as the equipment manufacturer incurs rework costs, resubmission to the independent test lab costs, further delays to revenue generation as the product is removed from the market and delay in the delivery of games put on hold until the rework is completed. Field issues process 750 starts once the product receives regulatory approval and placement in the market is complete. As can be seen from FIG. 7B, a field issue affects four different entities: (1) one or more operators of the equipment; (2) independent test laboratories; (3) regulatory authorities; and (4) the equipment manufacturer of the affected equipment.

After a product is approved by the regulators for use at step 360, it is placed in the field at an operator location at step 755. It is usually the operator that discovers there is a field issue requiring attention. Upon first being identified at step 760, the operator notifies the equipment manufacturer of the issue at step 765. The equipment manufacturer then alerts the regulator and the independent test lab of the issue at step 770. The independent test lab researches its various databases 772 to determine whether the issue was missed during testing while at the same time, the manufacturer works cooperatively with the test lab to determine the cause of the issue and potential workaround solutions at step 774. The regulators are also notified of the test laboratory's findings and the regulator decides whether to recall the product at decision step 776. If it is determined that the product needs to be recalled, the product is removed from all operators in the affected markets at step 778. The equipment manufacturer then reworks the product at step 780 to address and resolve the issue. A rework includes redevelopment and retesting for quality assurance on the new version of the product at step 782 following the same steps of quality assurance and compliance testing as described above. Once the development and quality assurance steps are completed, the product is resubmitted to the independent test lab to be re-tested for certification at step 782. To re-certify the product affected by a field issue, the test lab performs certification testing, executes certification reports and sends the report to the regulators and equipment manufacturers. Once the product has received regulatory approval at step 784, it is returned to the market at step 786.

Going back to step 776, if the regulator determines that the defect does not require a recall, the product is allowed to remain in the field at step 788. The type of field issue where a recall and rework of the product is not required involves a change not affecting gaming revenues or game integrity. This would also include cosmetic changes to the device such as graphic art or other exterior designs on the cabinet. At step 782, if retest of the product reveals that the problem has not been fixed, the product is returned for further rework at step 780.

FIG. 8 is a diagram showing known and hidden costs of the regulatory compliance approval process. The known costs 805 include: operational costs of the technical compliance department, fees charged by the testing laboratory, license and certification fees, etc. Using an approach to identify the total cost, a set of “hidden” or “unknown costs” 810 have now been identified and quantified. The hidden costs include: costs associated with a delayed launch, time and expenses incurred for field services to interface with customers to retrofit products in the field, and the cost of rework should a product be pulled from the field and modified, etc. In general, the total cost of compliance is equal to the sum of the internal costs, external costs, delay costs and costs associated with a probability of failure. This may be expressed in equation form as follows:

Total Cost of Compliance=ΣInternal Cost+External Costs+Delay Costs+Probability of Failure [1]
Where,
Internal=Costs of all staff time and operational expenses related to compliance matters;
External=Costs of license fees and laboratory fees, shipping, notification fees, etc. related to compliance;
Delay=Costs associated with delayed entry of product to market due to compliance issues or field issues; and
Probability of Failure=Costs associated with failure multiplied by the probability that a failure will occur.

FIG. 9 is a diagram showing a total cost of compliance system 900. In the system, there is a server 905 that serves a number of client computers 910a-e that allow various constituencies to access server 905. Server 905 runs software for tracking all time and costs of regulatory compliance and maintains a database of all data entered by the different constituencies. Server 905 determines the total cost of compliance for a gaming equipment manufacturer by applying the above equation [1] for all entries made by the different constituencies.

Client computer 910a is accessible to gaming equipment manufacturer employees whose job requires them to engage in regulatory compliance matters, but where regulatory compliance is not their primary focus. Such individuals include employees in marketing and sales, development, quality assurance, production, service and executive management. These employees use client computer interface 910a to enter time into a database that captures all time spent on regulatory compliance. It should be understood that client computer 910a in FIG. 9 merely represents access to server 905, and it should be understood that each employee may actually access system 900 on their own computer, terminal or other device such as a smartphone or a tablet computer having a web-browser that may act as an interface to software running on server 905 for tracking regulatory compliance costs.

Client computer 910b is the same as client computer 910a, except that it represents access for all gaming equipment manufacturer employees whose primary job function is compliance. For these employees, all of their time is allocated to regulatory compliance and they also enter any regulatory compliance fees charged by testing laboratories as well as fines, licensing fees and costs such as shipping and other hard costs associated with the efforts to obtain regulatory compliance approval and certification.

All costs entered by gaming equipment employees on client computers 910a and the automated employee wages, salaries and benefits captured on computer 910b are considered internal costs. A separate category of external costs must also be gathered. The external costs are typically the costs associated with any regulatory compliance fees charged by testing laboratories as well as fines, licensing fees and other hard costs such as shipping notification fees and costs associated with the efforts to obtain regulatory compliance approval and certification. External costs may also include modification or retrofitting of products in the field that have been sold or otherwise placed with customers, but are later found to be out of compliance and may even be temporarily recalled from the market. As shown in FIG. 9, the employees who account for external costs are likely to be production workers who must have products retrofit with new components as well as service employees who may need to have products modified in the field. These employees may also have travel costs and component costs that they may enter into the database residing on server 905 or into the client server 910c which interfaces with server 905. Executive management may also get involved in the modification and retrofitting process and have access to server 905 to enter their time and expenses. Executive management may also have expenses required for meetings with regulatory agency personnel, testing laboratory personnel and/or customers to work through product issues for products that require retrofitting. In addition, it is not uncommon for executive management to be called upon to explain to regulators the cause of the problem and what the gaming equipment manufacturer is doing to ensure the issue will not reoccur.

Another client computer 910d represents the entry of time and costs related to any delays associated with testing and re-testing of products either at the time of submission to the testing laboratory or after a problem is detected that causes a product to require retrofitting or modification. The costs associated with delay are typically handled by sales and marketing when a sale is lost due to delay in product availability or a customer no longer wanting the product due to loss of credibility in product quality.

A fifth client computer 910e represents the entry of time and costs related to the probability of failure costs. These costs include the number of products revoked or returned over a set period of time (e.g. 12 months). The quantification of loss of credibility for the gaming manufacturer and any extra effort and diligence needed to regain credibility with regulators and/or customers may also be calculated. The compliance department is shown as the organizational entity making entries for this category, but other entities, such as for example, sales and marketing, may also account for a portion of probability of failure costs.

A separate representation of the product development and deployment lifecycle is shown in FIG. 10, which presents the product development and deployment lifecycle in a framework similar to FIGS. 4A and 6, but broken down by the different cost components and where such costs may occur in the process. As can be seen in FIG. 10, a process is shown that starts with the step of conceptualizing or analyzing a new product 305. The product moves to the design phase 310 and then development 315 takes place. Quality assurance testing 320 follows and submission 425 of the new product is made to a test lab for compliance testing 325. Regulatory approval 360 is performed and the product is installed 1005 in the field. The organizational entities responsible for the different steps along the way are shown in the bar above the process. The research and development groups 705, 710 of the equipment manufacturer are responsible for steps 305, 310, 315, and 320. Technical compliance 725 of the equipment manufacturer is responsible for submission at step 425. The independent testing laboratory 730 handles testing 325 while the regulators 735 handle approval 360 and the field service organization 740 of the gaming equipment manufacturer installs and repairs the product.

The different cost components are shown below the process steps. Internal costs 1010 are shown extending across steps 305, 310, 315, 320, 425. External costs 1015 are shown extending to the independent test lab and the regulators in steps 325 and 360 while failure costs 1025 are shown attributable to field operations 1005. Delay costs 1020 extend across the entire process and may be associated with any of the organizational entities. Opportunity costs 1030 are a sub-component of delay costs and are shown as the arrows moving back from right to left when backtracking is required across the process.

Once all organizational entities have entered time and costs for any particular time period, the total cost of compliance may be calculated. Due to the way that time and costs are entered, the gaming equipment manufacturer may not only determine the total cost of compliance, but it may also review detailed reports of individual departments and the allocation of costs and expenses for that department by product, product type, time period, jurisdiction and a host of other metrics to provide valuable intelligence about the process for obtaining regulatory approvals and certifications. Analysis of the data will allow the gaming equipment manufacturer to better allocate resources and to lower the overall costs of compliance by focusing efforts on problem areas revealed by the data.

FIG. 11 shows a block diagram of an alternative embodiment for a process to test and certify equipment for regulatory compliance and showing system components associated with the overall process. It should be understood that the system components are the same as those described with respect to FIGS. 5-6 and as such, those components have the same reference numbers. For a description of the operation of the system components, refer to the description of those components above.

In this embodiment, a separate, independent quality assurance arm of the testing laboratory actually performs and delivers all of the quality assurance steps 1110-1130 making up the quality assurance block 1105. In a manner similar to the embodiment described above with respect to FIG. 6, the quality assurance step 1105 is made up of a group of substeps including integrating QA and compliance checklists 1110, running math and source code tests, 1115, running test scripts 1120, preparing test reports 1125, and developing and submitting a package to the compliance testing laboratory 1130. Instead of being performed by the gaming equipment manufacturer, the testing laboratory is contracted to perform quality assurance and the work is performed by a separate arm of the testing laboratory. It is important to note that the independent quality assurance arm of the testing laboratory is a completely separate entity, both organizationally and physically, from the compliance testing laboratory. This quality assurance team receives software from the client development team at step 1135 as indicated by arrow 1140. While there is testing performed by the gaming equipment manufacturer throughout the development cycle, the final quality assurance (“QA”) testing performed by the QA arm of the testing laboratory is conducted once a release build (which is a pre-release version of a software program or product that is ready to enter the quality assurance testing phase) has been completed and prior to a certification build (which is a pre-release version of a software program or product that has passed the QA testing phase and is ready to enter the compliance testing phase) is submitted to a compliance testing laboratory for testing. The release build may be made up of various component pieces that may already have been tested by the QA arm of the testing laboratory, The QA arm of the testing laboratory will run the release build of the product through QA testing substeps 1110-1125 and provide a QA test report back to the manufacturer's development team indicated by arrow 1145 that describes what defects were found during testing.

The development team makes changes to the software based on the QA test report and provides a new software version to the testing laboratory QA team for testing. The QA arm and the manufacturer continue to refine development and test the different software versions until a release build satisfies the testing laboratory's independent QA arm, at which point a submission package is developed and submitted by the compliance testing laboratory at step 1130. There may be two or more iterations of the refinement as the work is completed across steps 1135, 1110, 1115, 1120 and 1125. As a part of the QA testing performed by the separate QA arm of the testing laboratory, pre-certification tests are run on the release builds, thereby finding technical and regulatory problems at the earliest possible time and lowest cost to the gaming equipment manufacturer. In addition, the QA arm of the testing laboratory will have access to all the tools available to the testing laboratory and benefit from the use of these tools when performing their QA pre-certification testing. The QA teams of the testing laboratory will not be involved with the certification testing at all. The compliance arm of the testing laboratory will conduct independent certification testing once the QA process has been completed. A dashed line 1180 shows the separation between the QA arm of the testing laboratory and the compliance arm of the testing laboratory.

Once the package has been submitted to the compliance testing laboratory at step 1130, the certification build is passed through to compliance testing 1155 that is an independent testing arm organizationally distinct from the QA arm at arrow 1150. Compliance testing is performed at 1155 by the compliance arm and if any defects are found, which should be unlikely at this point given that QA has completed its work, the compliance arm prepares a report and sends it back to the QA arm for review at arrow 1160. Any changes required in the product are then communicated by the QA arm of the testing laboratory to the manufacturer at arrow 1145 which revises the product and sends it back through QA again at arrow 1140. If the product makes it through the QA substeps 1110-1130 and compliance testing 1155 without further issues, a certification report is provided at step 1165 and the product is released by the manufacturer to the regulators at step 1170. Regulatory approval follows at step 1175 and is issued by the regulators.

The QA arm of the testing laboratory performs all areas of QA. The types of QA testing to be performed by the QA arm of the test lab at steps 1115 and 1120 includes, but is not limited to the following tests:

Functional testing: Testing is performed to verify a specific action or function of software code or hardware operations. For software, the functions to be tested are usually found in the code requirements documentation, although some development methodologies work from use cases or user stories. Functional tests tend to answer the question of “can the user do this” or “does this particular feature work.”

Acceptance testing: Acceptance testing is testing by the end user of the software that verifies the software works as desired. This is one of the final stages of a project before the customer accepts the new system or software project.

System testing: Testing is performed on a completely integrated system to verify that it meets all requirements.

Installation testing: Testing is performed to assure that the system is installed correctly and working on all targeted hardware.

Compatibility testing: Testing is performed on the application to evaluate the application's compatibility with the computing environment (CPU, memory, hard drives, etc).

Pre-Compliance Testing: Testing is performed to determine if a system meets regulatory standards.

Smoke testing: Testing is performed to determine whether there are serious problems with a new build or release. Smoke testing is an acceptance test that occurs prior to introducing a build to the main testing process.

Sanity testing: Testing is performed to determine whether it is reasonable to proceed with further testing. Sanity testing is a brief run through of the software's functionality that indicates that the product works as expected.

Regression testing: Testing is performed focusing on finding defects after a major code change has occurred. Specifically, it seeks to uncover previously existing bugs that remain hidden in the code.

Destructive testing: Testing is performed to identify the cause of a software or a sub-system failure.

Performance testing (load & stress): Testing is performed to determine how a system or sub-system performs in terms of responsiveness and stability under a particular workload. It can also serve to investigate, measure, validate or verify other quality attributes of the system, such as scalability, reliability and resource usage.

Usability testing: Testing is performed to check if the user interface is easy to use and understand. It is concerned mainly with the use of the application.

Security & Penetration testing: Testing is performed on software that processes confidential data to ensure privacy and to prevent system intrusion by hackers.

Globalization (Internationalization) testing: Testing is performed to verify the functional support for a particular culture/locale including different languages, regional differences and technical requirements for a specific market.

Localization testing: Testing is performed to translate the product user interface and may change some initial settings to make it suitable for another region/locale. Localization testing checks the quality of a product's localization for a particular target culture/locale.

Integration or API testing: Testing is performed on the software to verify the interfaces between components against a software design.

Automation testing: Testing is in the form of the creation and use of software, separate from the software being tested, to control the execution of tests and the comparison of actual outcomes to predicted outcomes.

Dev testing: Testing is performed that involves synchronized application of a broad spectrum of defect prevention and detection strategies in order to reduce software development risks, time, and costs. It is performed by the QA engineer during the construction phase of the software development lifecycle.

Black box testing: Testing is performed that treats the software as a “black box”, examining functionality without any knowledge of the internal source code.

White box testing: Testing is performed to test internal structures or workings of a program, as opposed to the functionality exposed to the end-user. In white-box testing an internal perspective of the system, as well as programming skills, are used to design test cases.

Gray box testing: Testing is performed involving having knowledge of internal data structures and algorithms for purposes of designing tests, while executing those tests at the user, or black-box level.

Managed services: Testing is performed to test the practice of outsourcing day-to-day management responsibilities as a strategic method for improving operations and cutting expenses.

Outsourcing: Contracting out of a business process to a third-party.

QA Governance: A subset discipline of corporate governance focused on QA systems and their performance and risk management.

In this embodiment, the Total Cost of Compliance continues to be calculated and measured, and cost reduction areas identified and implemented. However, whereas the Total Cost of Compliance has focused on the quality as it relates to how well the regulatory requirements of the product have been addressed, in this alternative embodiment, the Total Cost of Compliance is a single variable in the Total Cost of Product Quality. The Total Cost of Product Quality measures not only the costs associated with meeting the regulatory requirements needed for the product to be approved for placement in the jurisdiction, but costs incurred throughout the Quality Assurance subprocesses.

Total Cost of Product Quality=ΣQuality Assurance Costs+Total Cost of Compliance+Rework Costs
Where,
Quality Assurance=Costs of all staff time and operational expenses related to quality assurance subprocesses;
Total Cost of Compliance=Costs defined previously in this document
Rework=Costs associated with correcting defects in the product from a product development, quality assurance, production, field services and any additional departments that may expend resources on correcting defects in the product.

Analysis of the Total Cost of Product Quality provides the ability to determine if relationships exist between each of the elements described that make up the Total Cost of Product Quality. As an example, the data may indicate that the cost of rework is a large portion of the Total Cost of Product Quality. The gaming equipment manufacturer in conjunction with the testing laboratory may determine that if additional resources are provided in Quality Assurance, the rework costs are reduced.

FIG. 12 is a diagram showing the Total Cost of Product Quality reporting system 1200 and how this computer system interfaces with Total Cost of Compliance system 900 and Test Lab Toolbox system 500.

The Total Cost of Product Quality Reporting system 1200 consists of a client configuration engine and server 1205 that is capable of customizing the data capture and calculating the sum of the internal and external costs 910a, 910b, 910c, for each client. It also contains a server 1210 that captures and calculates the sum of delay costs (910d) and the probability of failure costs (910e) for each client. In addition, both server 1205 and server 1210 contain application program interfaces (APIs), including those for mobile or hand held devices, that allow personalized data input.

This system is also comprised of a reporting module 1215 that interfaces with Toolbox Report module 540 and Total Cost of Compliance System 900 reporting module to extract all costs associated with the total cost of product quality for a specific equipment operator. It also identifies trends in how the total cost of compliance has varied over time.

While the invention has been described with respect to the figures, it will be appreciated that many modifications and changes may be made by those skilled in the art without departing from the spirit of the invention. Any variation and derivation from the above description and drawings are included in the scope of the present invention as defined by the claims.

What is claimed is:

1. A system for determining the cost of regulatory compliance for an equipment manufacturer:
a server for hosting the system on a network including an interface to the system for use by users;
a time and expense database accessible by the server to store time entries of users tasked with compliance related matters where time entries are associated with a particular product and for a particular time period, and expenses related to compliance related matters by product type;
at least one input device on which individuals enter time and expenses in the time and expense database; and
wherein the total cost of compliance is calculated by the server from entries in the time and expense database according to an equation as follows:
Total Cost of Compliance=ΣInternal+External+Delay+Probability of Failure
Where,
Internal=number of hours of staff time spent working on compliance related matters multiplied by a corresponding hourly rate for each staff member and the cost of activities and operations attributable to compliance, including but not limited to supplies, equipment, tools, office space, utilities, and travel;
External=Expenses of regulatory license and certification fees, laboratory fees, shipping notification costs and other fees attributable to the cost of testing, approval and certification for compliance of product;
Delay=Expenses associated with delayed entry of product to market due to compliance issues; and
Probability of Failure=Expenses attributable to a failure of a product multiplied by a probability that a failure will occur.

2. The system of claim 1 wherein the total cost of compliance is calculated by the server from entries in the time and expense database for an individual product.

3. The system of claim 1 wherein the total cost of compliance is calculated by the server from entries in the time and expense database for a particular time period.

4. The system of claim 1 wherein the total cost of compliance is calculated by the server from entries in the time and expense database for each step in the lifecycle of product development and deployment for at least one of conceptualization, design, development, quality assurance, submission, laboratory testing, regulatory approval and commercialization.

5. The system of claim 1 wherein the total cost of compliance is calculated by the server from entries in the time and expense database for each organizational entity involved in a product lifecycle for at least one of the types of costs comprising: (a) design, (b) research & development, (c) quality assurance, (d) rectification, (e) technical compliance, (f) testing laboratory, (g) regulators, (h) field services, (h) marketing, (i) sales, (j) executive management, and (k) other organizational entities required to handle compliance related matters.

6. The system of claim 1 wherein the system further calculates the total cost of product quality according to an equation as follows:
Total Cost of Product Quality=ΣQuality Assurance Costs+Total Cost of Compliance+Rework Costs
Where,
Quality Assurance Costs=Costs of all staff time and operational expenses related to quality assurance subprocesses;
Rework=Costs associated with correcting defects in the product from a product development, quality assurance, production, field services and any additional departments that may expend resources on correcting defects in the product.

7. A method for determining the cost of regulatory compliance of a product of an equipment manufacturer, the method comprising:
providing a server for hosting the system on a network including an interface to the system for use by users;
establishing access to a time and expense database accessible by the server wherein the time and expense database stores time entries of users tasked with compliance related matters where time entries may be associated with a particular product and for a particular time period, and expenses related to compliance related matters by product type;
inputting data by at least one user on an input device to the time and expense database;
calculating a total cost of compliance by the server from entries in the time and expense database according to an equation as follows:
Total Cost of Compliance=ΣInternal+External+Delay+Probability of Failure
Where,
Internal=number of hours of staff time spent working on compliance related matters multiplied by a corresponding hourly rate for each staff member and the cost of activities and operations attributable to compliance, including but not limited to supplies, equipment, tools, office space, utilities, and travel;
External=Expenses of regulatory license and certification fees, laboratory fees, shipping notification costs and other fees attributable to the cost of testing, approval and certification for compliance of product;
Delay=Expenses associated with delayed entry of product to market due to compliance issues; and
Probability of Failure=Expenses attributable to a failure of a product multiplied by a probability that a failure will occur; and
providing a total cost of compliance report calculated by the server from entries in the time and expense database to at least one user on the input device.

8. The method of claim 7 wherein the total cost of compliance may be calculated by the server from entries in the time and expense database for an individual product.

9. The method of claim 7 wherein the total cost of compliance may be calculated by the server from entries in the time and expense database for a particular time period.

10. The method of claim 7 wherein the total cost of compliance may be calculated by the server from entries in the time and expense database for each step in the lifecycle of product development and deployment for at least one of conceptualization, design, development, quality assurance, submission, laboratory testing, regulatory approval and commercialization.

11. The method of claim 7 wherein the total cost of compliance may be calculated by the server from entries in the time and expense database for each organizational entity involved in a product lifecycle for at least one of design, research & development, quality assurance, rectification, technical compliance, testing laboratory, regulators, field services, marketing, sales, executive management and other organizational entities required to handle compliance related matters.

12. The method of claim 7 wherein the system further calculates the total cost of product quality according to an equation as follows:
Total Cost of Product Quality=ΣQuality Assurance Costs+Total Cost of Compliance+Rework Costs
Where,
Quality Assurance Costs=Costs of all staff time and operational expenses related to quality assurance subprocesses;
Rework=Costs associated with correcting defects in the product from a product development, quality assurance, production, field services and any additional departments that may expend resources on correcting defects in the product; and
providing a total cost of compliance report calculated by the server from entries in the time and expense database to at least one user on the input device
